(19) United States
(12) Patent Application Publication
(10) Pub. No.: US 2011/0062732 A1
(43) Pub. Date: Mar. 17, 2011

(54) LOW-COST PAGE-TURNING AID

(76) Inventor: Pascal Roland SUARD, Monthey (CH)

(21) Appl. No.: 12/561,934

(22) Filed: Sep. 17, 2009

(51) Int. Cl. B42D 9/04; B25J 1/00

(52) U.S. Cl. 294/25

(57) ABSTRACT

An apparatus that is placed upon a user's fingertip and assists the user in turning the pages of a magazine, newspaper, book or other composition, is disclosed. The apparatus includes a thin, flexible base layer, which may be capable of being printed upon; and a thin and flexible interface layer. The interface layer may be a frictional material, such as a rubber, or an adhesive material.

### BACKGROUND OF THE INVENTION

1. Field of the Invention

The present invention relates to an apparatus that assists a user in turning the pages of a magazine, newspaper, or other composition, and, more specifically, to an apparatus that worn on the user's finger, and is thin, lightweight, and disposable.

2. Description of the Prior Art

Throughout any normal day we are presented with periods of time where we are given the chance to review a newspaper or magazine—during a morning coffee at a local cafe, while waiting at the doctor's office, or upon finding an abandoned periodical on the train. Reading such magazines and newspapers is an enjoyable way to pass time, but may result in dirty, or newsprint covered hands. Additionally, at times we are presented with pages that are stuck together and tough to turn. The traditional fix, of licking your fingers and then separating the pages, is not an ideal solution when reading a public or abandoned periodical.

What is needed is a single-use, disposable page-turning aid, which creates a frictional region at the tip of the reader's finger(s) and provides the casual reader the ability to keep his or her hands clean while reading a publicly available periodical. This page-turning aid should be easy to figure out upon first glance, made of minimal material, and provided at no additional cost to the reader. A small page-turning aid can be easily provided in multiplicity with the periodical, allowing for multiple successive readers to each enjoy the same magazine or newspaper. Additionally, with the page-turning aid comprised of a paper, or substantially paper material, the aid can be printed on and provide the periodical publisher with additional revenue through commercial advertising.

### SUMMARY OF THE INVENTION

Briefly, an apparatus to assist an individual in turning the pages of a newspaper, magazine, book, or other periodical or composition is disclosed. The apparatus is made of an inexpensive, flexible, lightweight material, for example paper, and may come in a variety of conformations, each of which snugly fit the tip of a user's finger. The apparatus has an inside surface and outside surface, with an adhesive or frictional layer on at least the outside surface. The apparatus is either tightly wrapped or affixed to the user's fingertip, and the outside adhesive or frictional layer allows the user to more easily turn the pages of the composition.

Additionally, the apparatus may be printed on by advertisers, and/or supplied free of charge for use with periodicals, such as newspapers and magazines, that are available in publicly accessible places. This system of distribution provides users the ability to read publicly available materials while maintaining a sense of cleanliness, and provides publishing companies and printers with an additional source of revenue.

### IN THE DRAWINGS

FIGS. 1(a)-(c) show an embodiment of the present invention, in a flat finger-wrap conformation.

FIGS. 2(a)-(c) show another embodiment of the present invention, in flattened thimble-conformation.

FIGS. 3(a)-(c) show yet another embodiment of the present invention in rounded thimble-conformation.

### DETAILED DESCRIPTION OF THE PREFERRED EMBODIMENTS

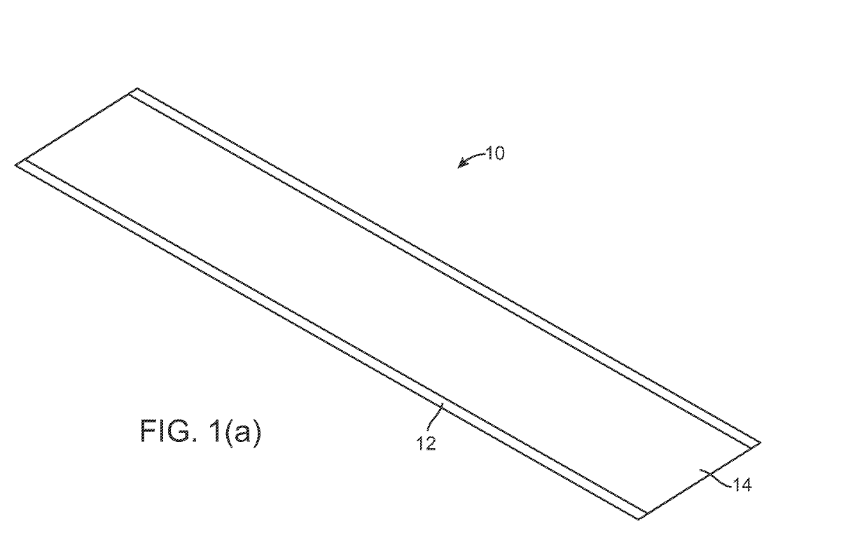

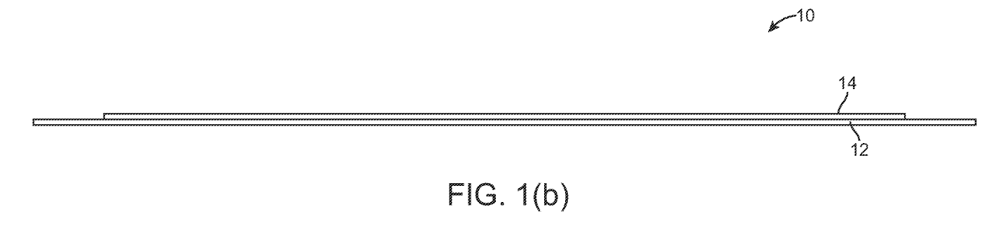

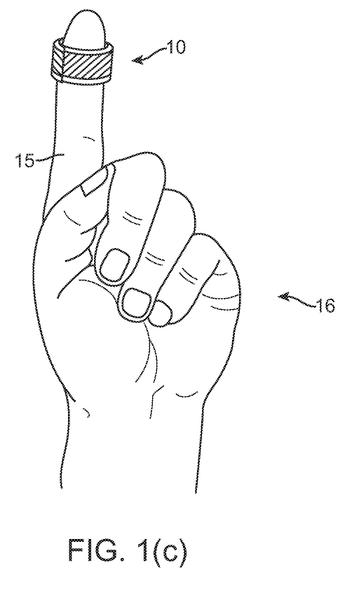

Referring now to FIG. 1(a), an angular view of flat finger-wrap page-turning aid 10 is shown, in accordance with an embodiment of the present invention. Flat finger-wrap page-turning aid 10 is comprised of base strip 12 and interface layer 14. Base strip 12 is comprised substantially of any material that is flexible, to allow for wrapping around a finger; smooth, to avoid damage of the skin; strong enough to avoid tearing when pulled by a force perpendicular to the plane of its surfaces, and capable of being printed on the outer face of base strip 12, beneath interface layer 14. Exemplary materials for base strip 12 include, for example, paper, a cotton fiber reinforced paper, or DuPont™ Tyvek®.

Interface layer 14 of finger-wrap page-turning aid 10 is the layer which interfaces with the pages being turned, and is formed on top of base strip 12. Interface layer 14 may be a high-friction material, for example, rubber; or may be an adhesive that is strong enough to adhere to and release from the pages of a newspaper or book for hundreds of cycles, but not strong enough so as to tear the pages being turned. Interface layer 14 may be transparent, so that any printing on base strip 12 is visible to the user. When interface layer 14 is comprised of an opaque adhesive or rubber, interface layer 14 may be capable of having text or graphics printed thereon, so that a visible printed area is not lost. Interface layer 14 should be thin, so as not to destroy the flexibility of base strip 12, allowing finger-wrap 10 to be easily and tightly wound around a user's finger. Where interface layer 14 is an adhesive, it may be tear-resistant, adhere firmly to turned pages yet be easily removable with clear release, durable and disposable, and easy to apply to base strip 12.

FIG. 1(b) shows a side view of finger-wrap page-turning aid 10. Interface layer 14 is formed directly upon base strip 12 without any intermediate layers therebetween. In FIGS. 1(a) and (b), interface layer 14 is shown to be formed substantially covering the top surface of base strip 12, and in a substantially similar rectangular shape. In other embodiments of the present invention, interface layer 14 may take the conformation of round adhesive or rubber dots covering a surface of base strip 12; narrow adhesive/rubber strips alternating with non-adhesive or non-rubber areas; checkerboard patterning; lettering; or any other shapes and patterns formed onto base strip 12.

FIG. 1(c) shows page-turning aid 10 ready for use, wrapped around the tip of finger 15 of hand 16. Flat finger-wrap page-turning aid 10 may be wrapped around the tip of finger 15 at the furthest distance possible from hand 16 in order to maximize accessibility to the pages that will be turned. As finger-wrap 10 is located further down finger 15 towards hand 16 it may become more difficult for page-turning aid 10 to successfully contact the page to be turned; and more difficult for the other available fingers to assist in turning the page once page-turning aid 10 has contacted the page.

In order for page-turning aid 10 to be easily attached to finger 15 at least a small portion of either interface layer 14 or base strip 12 should be adhesive. In accordance with an embodiment of the present invention, the non-adhesive inner face of base strip 12 comes in contact with an adhesive portion of interface layer 14 when wrapped around finger 15, and thereby prevents page-turning aid 10 from unwrapping and falling off of finger 15. In an alternative embodiment of the present invention, the interface layer 14 comes in contact with an adhesive region on the inner face of base strip 12 when page-turning aid 10 is wrapped around finger 15, thereby preventing page-turning aid 10 from unwrapping and falling off of finger 15.

In yet another embodiment of the present invention, both the inner face of base strip 12, which contacts finger 15, and interface layer 14 may be treated with a frictional or adhesive material. In such a configuration, page-turning aid 10 may more easily remain fixed on the tip of finger 15 during use. Additionally, if both faces of base strip 12 include adhesive, then application by the user becomes simplified, as the user no longer needs to determine the proper orientation of page-turning aid 10 for wrapping around his or her finger.

Finger-wrap page-turning aid 10 may function as intended in any of a variety of lengths and widths. Preferably, base strip 12 is about 70 mm to 120 mm long, and about 6 mm to 35 mm wide. Preferably, base strip 12 is a quadrilateral, and, more preferably, is rectangular, with opposing edges being of substantially identical lengths so that multiple page-turning aids 10 may be cut from a single, larger sheet. For example, a square of base strip 12 material which is 120 mm by 120 mm may be cut 19 times along the same axis to create 20 page-turning aids 10, each of which are 6 mm by 120 mm.

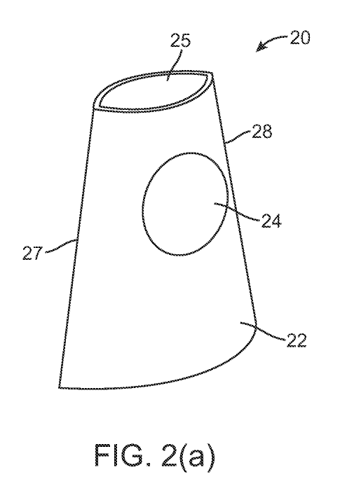

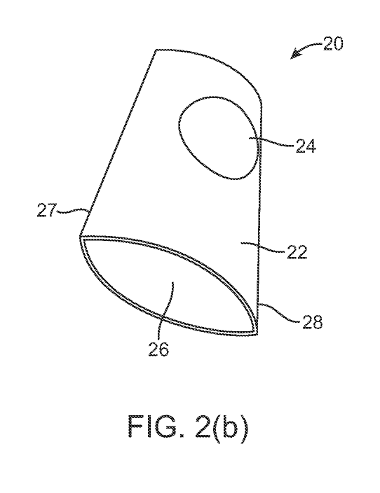

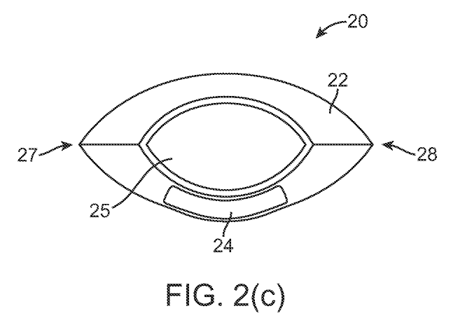

FIG. 2(a) shows a top angular view of a flattened thimble-conformation page-turning aid 20, in accordance with an alternative embodiment of the present invention. Flattened thimble-conformation page-turning aid 20 may be supplied to the user flattened, at edges 27 and 28, so that the user pops it open and then places upon their fingertip, positioned as demonstrated by page-turning aid 10 in FIG. 1(c). Page-turning aid 10 may offer a benefit over page-turning aid 20 because aid 10 is wound tightly around the user's finger, and thus it may provide a more custom fit and be less likely to inadvertently slip off. Because the same utility is desired of each page-turning aids 10 and 20, base strip 22 is made of substantially the same material as base strip 12 of page-turning aid 10; and interface dot 24 is made substantially of the same material as interface layer 14 of page-turning aid 10.

Top hole 25 may have a diameter of about 10 millimeters (mm) to 19 mm, which prevents page-turning aid 20 from sliding down the finger of an average adult. Bottom hole 26 (shown in FIG. 2(b)) may have a diameter in the range of 15 mm to 25 mm to ensure that page-turning aid 20 can fit over the finger of an average adult. The width of base strip 22, or height of page-turning aid 20 (the distance from top hole 25 to bottom hole 26), may range from about 25 mm to 35 mm, depending on various factors, such as the size of the printing desired and quantity of page-turning aids 20 to be distributed together.

FIG. 2(b) shows a bottom angular view of page-turning aid 20. Bottom hole 26 may be of a size that is large enough to allow the tip of a finger to pass through, but becomes snug around the finger as the finger widens and further enters page-turning aid 20 towards top hole 25 (as seen in FIG. 2(a)). For use on a thumb, page-turning aid 20 may have a bottom hole 26 diameter of about 25 mm; and for use on a an index finger, page-turning aid 20 may have a bottom hole 26 diameter of about 15 mm.

FIG. 2(c) shows a top view of flattened thimble-conformation page-turning aid 20. The top view more clearly shows the creases present at edges 27 and 28 due to page-turning aid 20 being flattened for distribution. Additionally, the top view of FIG. 2(c) better illustrates the size difference between bottom hole 26 (as seen in FIG. 2(b)), where the finger enters, and top hole 25, which has a smaller diameter opening so that page-turning aid fits snugly on the fingertip. Top hole 25 is small enough so that the user's finger does not continue through, and out of, page-turning aid 20, causing it to slide down the user's finger.

For particular users, page-turning aids 10 and 20 may be the preferred embodiment of the present invention because of the benefits conferred by a flattened device. Page-turning aids 10 and 20 are amenable to distribution within the periodical itself (e.g., between the pages), on the cover of the periodical, or for sending within an envelope via the United States Postal Service. Such options are of little additional cost for a publisher or distributor to supply with a periodical, or for separate mailing. Additionally, because page-turning aids 10 may be created in multiplicity, for example multiple page-turning aids 10 may be created and printed from a single common sheet (and then torn off by the individual users), aids 10 may be quicker to manufacture, and offer greater visibility to passersby.

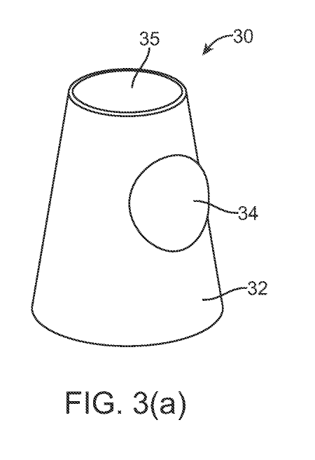

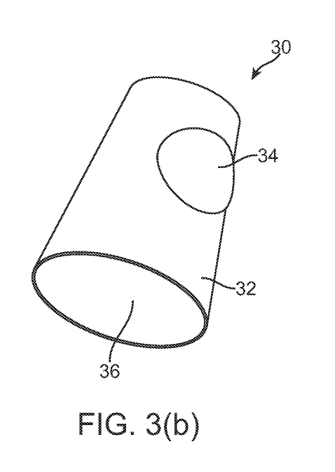

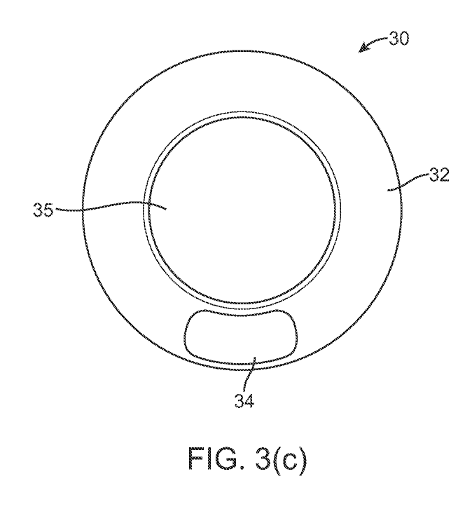

FIG. 3(a) shows an angular side view of rounded thimble-conformation page-turning aid 30, in accordance with an embodiment of the present invention. Other than the fact that page-turning aid 30 is not supplied to the user flattened like page-turning aid 20, these are substantially the same devices. Interface dot 34 is the same material and serves the same function as interface dot 24 of page-turning aid 20; and base strip 32 is the same material and serves the same function as base strip 22. Top hole 35 may allow a small portion of a user's finger to pass through, e.g., the tip of an index finger, but is of a diameter which disallows any significant portion of the user's finger from passing through. Top hole 35 may have a diameter of about 10 millimeters (mm) to 19 mm, which prevents page-turning aid 30 from sliding down the finger of an average adult.

FIG. 3(b) shows an angular bottom view of rounded thimble-conformation page-turning aid 30. Bottom hole 36 is sized so that the tip of a finger can be inserted snugly, and page-turning aid 30 will not be pulled off by the frictional forces generated by interface dot 34 contacting and adhering to paper.

The width of base strip 32, or height of page-turning aid 30 (the distance from top hole 35 to bottom hole 36), may range from about 25 mm to 35 mm, depending on factors such as the size of the printing desired, and quantity of page-turning aids 20 to be distributed together.

FIG. 3(c) shows a top view of rounded-thimble conformation page-turning aid 30. The top view more clearly shows the rounded conformation of page-turning aid 30, and that it lacks the creases found at edges 27 and 28 on page-turning aid 20, due to flattening of page-turning aid 20. The top view of page-turning aid 30 in FIG. 3(c) also illustrates the size difference between bottom hole 36, where the finger enters, and top hole 35, which has a smaller diameter opening so that page-turning aid fits snugly on the fingertip. Top hole 35 is small enough so that the user's finger does not continue through, and out of, page-turning aid 30, causing it to slide down the user's finger. Bottom hole 36 may have a diameter in the range of 15 mm to 25 mm to ensure that page-turning aid 30 can fit over the finger of an average adult.

An advantage of page-turning aid 30 is that a multiplicity of page-turning aids 30 may be supplied in stack, similar to drinking cups at a water cooler, at a location where individuals may find and borrow communal periodicals. For example, a stack of page-turning aids 30 may be found on the table at a doctor's office, or periodical rack at a library, where the aids 30 are clearly visible and easily accessible. In such circumstances, aids 30 may be conducive to individuals reading where they otherwise might abstain from handling communal periodicals for a variety of reasons, e.g., for fear of catching the flu.

In alternative embodiments of the present invention interface dot 34 is not restricted to being round shaped. The material used for interface dot 34 may completely cover the outer face of base strip 32, or may constitute any intermediate level of coverage between the two extremes, i.e. rings, lettering, or other patterns of frictional rubber or adhesive material which partially cover base strip 32's outside face.

Although the present invention has been described in terms of specific embodiment, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1. A method of turning a page comprising:
placing a page-turning aid on the tip of a finger;
touching the page-turning aid a page; and
moving the page-turning aid in the direction the page is desired to be turned.

2. The method of claim 1, further placing the page-turning aid on an index finger.

3. The method of claim 1, further placing the page-turning aid on a thumb.

4. The method of claim 2, further moving the page by a frictional force between the page-turning aid and the page.

5. The method of claim 2, further moving the page by an adhesive on the outer surface of the page-turning aid.

6. An apparatus to assist in turning a page comprising:
a thin, flexible base layer; and
a flexible interface layer fixed upon said flexible base layer.

7. The apparatus of claim 6, wherein the flexible base layer is made of paper, cotton, or of a paper and cotton blend, and is capable of having graphics and text printed thereon.

8. The apparatus of claim 7, wherein the flexible interface layer is a rubber.

9. The apparatus of claim 7, wherein the flexible interface layer is an adhesive.

10. The apparatus of claim 7, wherein the flexible base layer is a quadrilateral, having four sides, and is about 70 mm to 120 mm long, and about 6 mm to 27 mm wide.

11. The apparatus of claim 10, wherein the flexible base layer is rectangular.

12. The apparatus of claim 11, further for placement upon a fingertip.

13. The apparatus of claim 9, wherein the flexible base layer is a thimble conformation, having a first hole and a second hole in substantially parallel planes to each other, where said first hole has a diameter of about 10 mm to 19 mm, and said second hole has a diameter of about 15 mm to 25 mm.

14. The apparatus of claim 13, wherein the first hole and the second hole are about 25 mm to 35 mm apart.

15. The apparatus of claim 14, further placed on a fingertip.
